(19) United States
(12) Patent Application Publication
(10) Pub. No.: US 2023/0216137 A1
(43) Pub. Date: Jul. 6, 2023

(54) PROPAGATION BARRIER FOR BATTERIES

(71) Applicant: Zentrum fur Sonnenenergie- und Wasserstoff-Forschung Baden-Wurttemberg Gemeinnutzige Stiftung, Stuttgart (DE)

(72) Inventors: Harry DOERING, Elchingen (DE); Marius BAUER, Ulm (DE); Daniel BECHER, Ehingen (DE); Fabian MENZ, Senden (DE); Olaf BOESE, Ulm (DE)

(21) Appl. No.: 17/928,343

(22) PCT Filed: Apr. 29, 2021
(86) PCT No.: PCT/EP2021/061212

§ 371 Date: Nov. 29, 2022

(30) Foreign Application Priority Data
May 29, 2020 (EP) 20177561.6

(51) Int. Cl. H01M 50/383; A62C 3/16; A62C 2/06

(52) U.S. Cl. CPC H01M 50/383; A62C 3/16; A62C 2/06

(57) ABSTRACT

The present invention relates to a barrier for preventing the propagation of a thermal event within a multi-cell battery module, comprising a framework structure and a heat-absorbing material, which comprises water and a component based on biogenic raw materials. Furthermore, the invention relates to a multi-cell battery module and a battery comprising at least one such barrier. Finally, the present invention also relates to a method for preventing the propagation of a thermal event within a multi-cell battery module.

### FIELD OF THE INVENTION

The present invention relates to a barrier for preventing the propagation of a thermal event within a multi-cell battery module, comprising a framework structure and a heat-absorbing material, which comprises water and a component based on biogenic raw materials. Furthermore, the invention relates to a multi-cell battery module and a battery comprising at least one such barrier. Finally, the present invention also relates to a method for preventing the propagation of a thermal event within a multi-cell battery module.

### Technical Background and Prior Art

In principle, thermal events can occur in all battery types. One of the most feared thermal events is battery thermal runaway (TR). This can occur when the rate at which the battery generates heat exceeds the rate at which the heat can be dissipated. If a critical temperature is exceeded, the heat-producing process taking place inside the battery intensifies itself and the battery heats up to several hundred degrees Celsius within a very short time. At the same time, there is an extreme increase in pressure in the cell, which can result in an explosive escape of decomposition gases and a fire.

In multi-cell battery modules, the danger emanating from such a thermal event is increased severalfold. The spacing between the individual cells does not provide sufficient protection against thermal runaway propagation. Due to the high temperature that occurs in the cell affected by the thermal runaway, the adjacent cells also heat up above the critical temperature. Accordingly, the thermal runaway of a single cell can easily lead to the destruction of the entire battery module.

Lithium-ion batteries are particularly susceptible to thermal runaway. These batteries have a significantly higher energy density than other battery types and release decomposition gases with a large proportion of oxygen, which can lead to even higher temperatures in the event of a failure. In addition, the risk of propagation of thermal events in lithium-ion battery modules is increased. The latter can be explained by the fact that a large proportion of lithium-ion battery modules are used in electric vehicles and portable electronic devices. The space requirement of the battery module is critical in both fields of application, so that many battery manufacturers have started to increase the packing density of the lithium-ion cells to the maximum. As a result, there is only little space available for barriers to prevent the propagation of thermal events, which in many cases results in insufficient thermal insulation between the cells.

Against this background, different barrier materials for batteries are proposed in the prior art.

WO 2010/017169 A1 also deals with the issue of thermal runaway in multi-cell battery packs, especially lithium-ion battery packs, and proposes strategies for preventing a thermal event from being transmitted from one battery cell to an adjacent battery cell. For this purpose, an element is provided which is suitable for arrangement between the cells of a multi-cell battery pack and contains a certain amount of water in the form of a hydrogel. The hydrogel is obtained using a polyacrylic acid superabsorbent. It is kept in a flexible bag or a dimensionally stable container and placed in the battery module. The flexible pouch packaging conforms to the shape of the battery cells to ensure heat transfer from the battery cell to the hydrogel. The container can be custom made to also make contact with the cell surface. However, the proposed element for suppressing thermal runaway is in need of improvement in several respects: On the one hand, the production of the element is not sustainable, since synthetically obtained polyacrylic acid is necessary to produce the hydrogel. On the other hand, the element can only function as a barrier to a limited extent. In the embodiment where the hydrogel is provided in a pouch packaging, there is no spacer between the cells that would survive the thermal runaway of an adjacent cell. Once the water has evaporated and the superabsorbent has decomposed, adjacent cells can come into direct contact with each other. In the embodiment in which the hydrogel is provided in a container, the cells are not in direct contact with one another, but the container walls formed from a solid material form a thermal bridge, through which the thermal event continues to propagate after the water contained in the hydrogel has evaporated.

In EP 3 550 662 A1 a heat absorption and heat insulation structure for a battery module is described, which comprises a battery module with a plurality of battery cells and a heat absorbing agent, wherein the heat absorbing agent is arranged between the plurality of battery cells and is able to generate gas. A phase change material (PCM) in the form of a hydrogenated salt is mentioned as an example of such a heat-absorbing agent. Furthermore, fire extinguishing agents, silicone oils or fluorinated liquids are mentioned as heat absorbing agents. However, none of the proposed heat-absorbing agents is particularly attractive for use in batteries: the silicone oil is a liquid and must therefore be surrounded by a dimensionally stable shell to ensure that it remains permanently in the desired location between the battery cells. In addition, the specific vaporization enthalpy of hexamethyldisiloxane (the silicone oil with a boiling point of 101° C.) is only about 204-222 J/g. Although a salt hydrate can be provided in a dimensionally stable form due to its solid state of aggregation and does not require a shell, however, the enthalpy of vaporization is insufficient even for the known salt hydrates. Fire extinguishing agents and fluorinated liquids are unsuitable per se as heat-absorbing agents because they are complex and expensive to produce.

US 2014/0224465 A1 discloses a thermal barrier system for a battery pack comprising a plurality of battery cells, the thermal barrier system comprising a thermal barrier disposed between each of the plurality of battery cells in the battery pack, said thermal barrier having a cross-sectional area at least equal to an adjacent battery cell, and wherein the thermal barrier includes a heat absorbing material in an amount sufficient to absorb heat dissipated from a failed battery. A hydrogel made of water and a hydrophilic superabsorbent polymer is preferably used as the heat-absorbing material, for example a hydrogel made of water and polyacrylamide or a copolymer of acrylamide and acrylic acid. A weakness of such a thermal barrier system, however, is again that its production is energy and resource-intensive.

### OBJECT OF THE INVENTION

Based on this prior art, the object of the present invention was to provide an improved barrier that is more sustainable in terms of production to prevent the propagation of a thermal event within a multi-cell battery module, and a corresponding battery module. Furthermore, the present invention has set itself the goal of specifying a sustainable method for preventing the propagation of a thermal event within a multi-cell battery module.

### SUMMARY OF THE INVENTION

This object or this goal is achieved by the barrier according to claim 1, the battery module according to claim 12 and the method according to claim 14.

According to the invention, a barrier for preventing the propagation of a thermal event within a multi-cell battery module is provided, wherein the barrier comprises a thermally and electrically insulating framework structure having a plurality of cavities which are at least partially filled with a heat-absorbing material, and wherein the heat-absorbing material comprises water and a component based on biogenic raw materials.

The thermally and electrically insulating framework structure is a heat-insulating element. It can delay the heat exchange between two neighboring cells of a multi-cell battery module and at the same time acts as a spacer. This also guarantees that no electrical short circuits can occur between the battery cells.

Because the framework structure has a plurality of cavities which are at least partially filled with a heat-absorbing material, the thermal insulation effect can be further increased. If a thermal event occurs in a cell of the battery module, the water contained in the heat-absorbing material is first heated to boiling point. Further heat is absorbed as the water evaporates. The water vapor then escapes to the environment, helping to prevent propagation of the thermal event and protecting the adjacent battery cell from a critical temperature rise.

In addition to the positive application properties, the fact that the barriers according to the invention comprise water and a component based on biogenic raw materials is particularly advantageous. Compared to other liquids, water has a relatively high specific heat capacity and specific enthalpy of vaporization. For this reason, water can absorb and dissipate a particularly large amount of heat. The component based on biogenic raw materials can give the heat-absorbing material greater strength. In addition, the use of synthetically manufactured superabsorbents can be avoided. This helps reduce the CO₂ footprint associated with the barrier's production process.

The term “biogenic raw materials” within in the meaning of the present invention includes organic raw materials that have been produced in agriculture and forestry or isolated from bacterial, yeast, fungal, aquaculture or marine cultures, as well as organic raw materials of animal origin, namely those that are anyway occur as a by-product of animal slaughter and require recycling. Furthermore, “biogenic raw materials” within the meaning of the present invention are biodegradable according to DIN EN 13432. The biogenic raw materials are opposed to fossil raw materials and petrochemical based energy sources, including substances that have been obtained through chemical synthesis processes and/or are not biodegradable.

In a preferred embodiment, the heat-absorbing material comprises 70-99.8% by weight of water and 0.2-30% by weight of a component based on biogenic raw materials. It is particularly preferred if the heat-absorbing material comprises 85-99.5% by weight of water and 0.5-15% by weight of a component based on biogenic raw materials. A high weight fraction of water ensures that large amounts of heat can be absorbed by the heat absorbing material. In addition, water is inexpensive and readily available in many places. The addition of a minimum proportion of a component based on biogenic raw materials makes it possible to give the heat-absorbing material more dimensional stability. In a further preferred variant of the invention, the heat-absorbing material comprises a hydrogel. The hydrogel is a network of at least one naturally occurring gelling agent and water. The gelling agent thus has the function of a water reservoir or binder.

The naturally occurring gelling agent can be a polysaccharide and/or be gelatin. If the naturally occurring gelling agent is a polysaccharide, it is preferably selected from the group consisting of agar-agar, starch, in particular corn starch, starch derivatives, hydroxypropylmethylcellulose, methylcellulose, κ-carrageenan, ι-carrageenan, pectin, gellan, scleroglucan, alginates and combinations thereof. The polysaccharide is particularly preferably selected from the group consisting of agar-agar, starch, in particular corn starch, starch derivatives, κ-carrageenan, ι-carrageenan, pectin, gellan, scleroglucan and combinations thereof.

Although the origin and composition of the polysaccharides mentioned above are known to those skilled in the art, individual polysaccharides are discussed in more detail below: Agar-agar is obtained from the cell walls of algae, such as blue or red algae. It essentially corresponds to a mixture of the polysaccharides agarose and agaropectin, with agarose preferably making up 60-80% by weight of the mixture. Agarose is a polysaccharide made from D-galactose and 3,6-anhydro-L-galactose linked together glycosidically. Agaropectin is a polysaccharide of β-1,4- and α-1-3-glycosidically linked D-galactose and 3,6-anhydro-L-galactose. About every tenth galactose residue is esterified at O-6 with sulfuric acid and contains additional sulfate moieties. Agar-agar is a very particularly preferred naturally occurring gelling agent within the meaning of the present invention. This is due to the fact that a hydrogel based on agar-agar is dimensionally stable at temperatures below about 85° C. and only releases water above this temperature.

κ-Carrageenan consists of repeating monomers of D-galactose-4-sulfate and 3,6-anhydro-D-galactose. ι-Carrageenan differs from κ-carrageenan only in that the 3,6-anhydro-D-galactose unit carries an additional sulfate group in the C-2 position. Both carrageenans occur in nature as the basic substance of the cell walls of a large number of red algae. Gellan is a polysaccharide comprising a repeat unit consisting of a rhamnose, a glucuronic acid and two glucose repeat units esterified with acetic acid and glyceric acid. It can be produced, for example, by the fermentation of carbohydrates by the bacterial strain Pseudomonas elodea.

Scleroglucan is a β-1,3-glucan that carries a glucose moiety as a side chain on average on every third sugar. Scleroglucan is preferably obtained from fungal cultures.

It is advantageous for the barrier according to the invention if the heat-absorbing material comprises 0.05-10% by weight, preferably 0.5 to 8% by weight, particularly preferably 0.5-5% by weight of at least one additive. The at least one additive is preferably selected from the group consisting of rheology modifiers, biocides, salts, flame retardants, dyes and combinations thereof. If the at least one additive comes from the group of rheology modifiers, it is preferably selected from the group consisting of xanthan, cellulose, carboxymethyl cellulose, gum arabic, guaran, maltodextrin and combinations thereof. Soweit das mindestens eine Additiv aus der Gruppe der Hydratsalze stammt, ist dieses bevorzugt aus der Gruppe bestehend aus Na₂CO₃·10H₂O, Na₂SO₄·10H₂O, Na₃PO₄·12H₂O and MgSO₄·7H₂O ausgewählt. The use of biocides as an additive can protect the heat-absorbing material in particular from attack by microorganisms and thus increases the durability of the barrier according to the invention.

In one variant of the present invention, the heat-absorbing material consists substantially of a hydrogel of at least one naturally occurring gelling agent and water and optional additives selected from the group consisting of rheology modifiers, biocides, salts, flame retardants, colorants and combinations thereof, which may be included in a proportion of up to 5% by weight, preferably in a proportion of up to 3% by weight.

Instead of a naturally occurring gelling agent, the heat absorbing material of the barrier can also contain cork particles that have been swollen in water. The cork particles can be obtained from larger pieces of cork or cork sheets by a grinding process and are preferably present as bulk material in the cavities of the framework structure.

Based on the volume of the cavities, the cavities of the framework structure are preferably at least 65% by volume, preferably at least 70% by volume, particularly preferably at least 90% by volume, in particular at least 98% by volume filled with the heat-absorbing material.

The framework structure preferably contains 60-100% by weight polymeric matrix material and 0-40% by weight fillers, particularly preferably 70-99% by weight polymeric matrix material and 1-30% by weight fillers. The polymeric matrix material can be selected from the group consisting of polyetheretherketone (PEEK), polyaramide, silicone and combinations thereof. The fillers, on the other hand, are preferably selected from the group consisting of clay, expanded clay, mica, glass, expanded glass, stone, cork particles and combinations thereof.

Polyetheretherketone (PEEK), polyaramide and silicone are suitable materials for the framework structure because they do not corrode in aqueous media, have a low specific weight and have a thermally insulating effect. Silicone is particularly preferred because of its good processing properties and low production costs. By using fillers, the compressibility or mechanical hardness and heat conduction properties of the framework structure can still be adapted to the respective requirements within certain limits. The fillers specified above are particularly advantageous for this purpose. On the one hand, they do not change their state in the range of 100-800° C. On the other hand, the thermal expansion coefficients of these materials in the range of 100-800° C. are also comparatively low.

Furthermore, it is preferred if the framework structure has a coating. The coating provides the framework structure with high heat resistance.

The plurality of cavities can be either ordered or disordered in the framework structure. If the framework structure is a solid foam, the plurality of cavities is disordered.

In a preferred embodiment, the cavities of the framework structure are sealed. In particular, the surface of the framework structure is sealed with a foil. The sealing can prevent the heat absorbing material from drying out before a thermal event occurs. The sealing preferably takes place with a polymer foil, a metal foil or a laminate of the aforementioned foils.

The polymer foil is preferably water impermeable and water insoluble. In addition, the water vapor permeability of the polymer foil, determined according to DIN 53122-2, is preferably low. The polymer foil can be selected in particular from the group consisting of polyethylene (PE), polypropylene (PP), polyvinylidene fluoride (PVDF), polychlorotrifluoroethylene (PCTFE), polyphenylene sulfide (PPS), ethylene-tetrafluoroethylene copolymer (ETFE) and combinations thereof. The metal foil is preferably an aluminum foil. A so-called “pouch” composite foil, for example, can be used as a laminate made of at least one polymer foil and at least one metal foil. This pouch composite foil comprises aluminum foil and is typically used to encase lithium-ion batteries.

The framework structure can be in the form of a foam. Alternatively, the framework structure can be formed as a layer having honeycomb, round and/or square cross-section cavities. In the case of a framework structure having honeycomb cross-section cavities, such as the “honeycomb aramid honeycombs”, which are sold commercially under the name Nomex®, it is preferred if the cavities have a size of 0.5 to 20 mm, preferably 0.5 to 10 mm, particularly preferably 3.0 to 9.0 mm.

The barrier is preferably present as a layer, in particular as a layer with an area that corresponds to at least 95% of the area of two battery cells that are to be shielded from one another by the barrier.

The layer thickness of the barrier is preferably 0.5 to 20 mm, particularly preferably 0.5 to 5 mm, very particularly preferably 0.5 to 2 mm.

A further aspect of the present invention consists in providing a multi-cell battery module or a battery comprising at least one of the barriers described above or a cork layer soaked in water, the cork layer soaked in water preferably comprising 30-45% by weight cork and 55-70% by weight water.

The at least one barrier or the cork layer soaked in water is preferably arranged in a space between two cells and/or in a space between an outer cell and a wall of the battery module. In the arrangement between an outer cell and a wall of the battery module, the barrier or the cork layer soaked in water also provides thermal insulation from the environment.

The battery cells contained in the battery module or in the battery can be stacked cells and the barrier is preferably arranged in at least one space between two stacked cells. An embodiment that is particularly interesting in terms of application technology is obtained when the stacked cells are lithium-ion stacked cells.

Finally, the present invention also provides a method for preventing the propagation of a thermal event within a multi-cell battery module. In this process, either one of the barriers described above or a cork layer soaked in water is arranged between the battery cells. The advantage of using the cork layer soaked in water is the simplified production. Since cork sheets are already manufactured for various applications, they only have to be cut to a suitable size and soaked in water.

### DESCRIPTION OF PREFERRED EMBODIMENTS

Preferred embodiments of the invention are explained in more detail with reference to the following examples, experiments and figures, without wishing to limit the invention thereto.

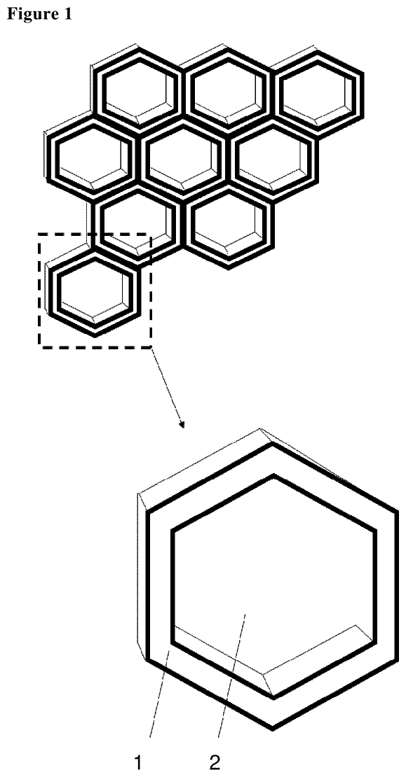

FIG. 1 shows a schematic of a framework structure 1, which is designed as a layer with honeycomb cross-section cavities 2.

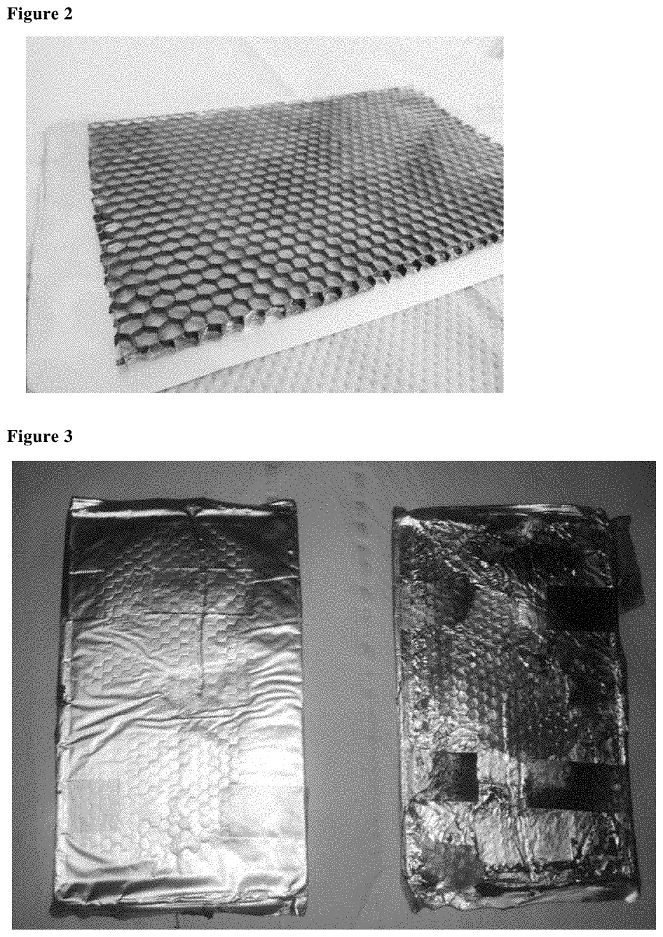

FIG. 2 shows a photograph of a barrier according to the invention without a sealing foil. The framework structure of the barrier is also designed here as a layer with honeycomb cross-section cavities.

FIG. 3 shows a photograph of two barriers according to the invention, in which the cavities of the framework structure are sealed with a pouch foil. The left barrier is unused, while the right barrier has already served to shield a thermal battery cell.

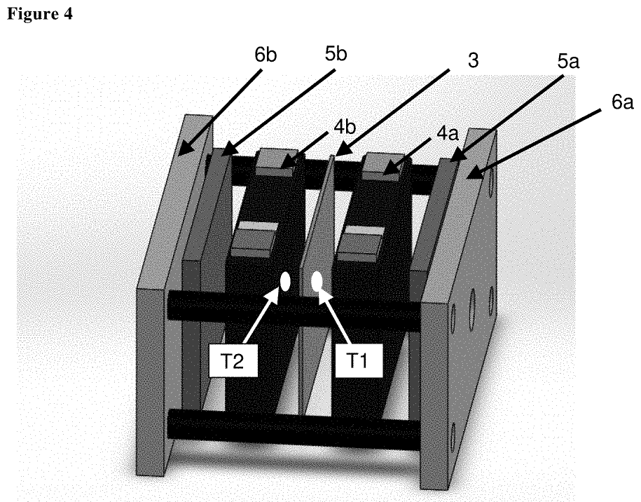

FIG. 4 shows the arrangement of a barrier 3 according to the invention in a battery (test) module comprising two battery cells 4a and 4b. 5a and 5b is a thermal insulation which, after the proactive triggering of the thermal event, prevents part of the released thermal energy from being absorbed by the clamping plates 6a and 6b, which have a certain thermal capacity. This avoids measurement errors. The clamping plates ensure the mechanical cohesion of the module. T1 and T2 show the measuring points where the temperature was measured. T1 is the temperature measurement point of the cell where the thermal event is triggered, and T2 is the temperature measurement point on the neighboring cell.

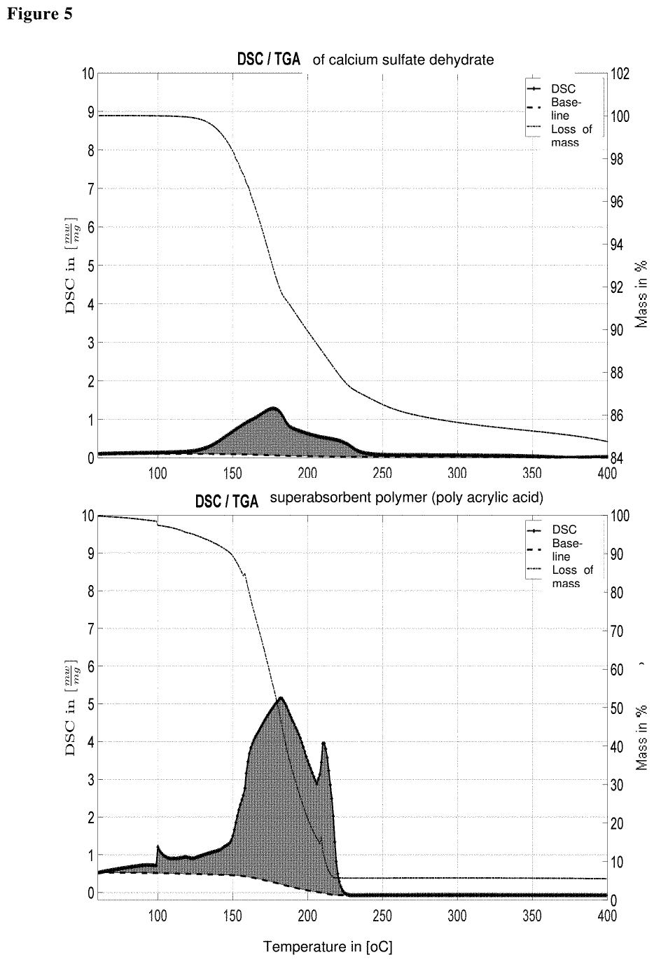

FIG. 5 shows the results of a thermogravimetric analysis (TGA) and differential scanning calorimetry (DSC) for samples of two different heat-absorbing reference materials, material 1 (see upper diagram) and material 2 (see lower diagram). Heating was at a rate of 10 K/min. Material 1 is a comparative material in which a salt hydrate (calcium sulfate dihydrate, CaSO₄·2H₂O) was introduced into a silicone matrix. Material 2 is a hydrogel obtained using conventional polyacrylic acid superabsorbent. The differential heat flow “DSC” is stated in mW/mg and is shown so that endothermic events in the sample pan are recorded as an upward excursion. Percent mass loss is plotted on the right y-axis. The specific vaporization enthalpy of material 1 based on this measurement was 351 J/g. The specific vaporization enthalpy of material 2 was 1185 J/g.

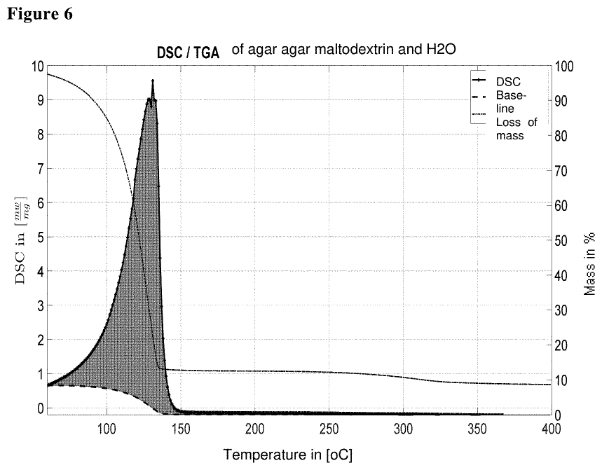

FIG. 6 shows the results of another combined TGA/DSC measurement with a heating rate of 10 K/min. A sample of a heat-absorbing material according to the invention consisting of 10% by weight gelling powder and 90% by weight water was measured, the gelling powder used consisting of about 30% by weight agar-agar and about 70% by weight maltodextrin. The differential heat flow “DSC” is stated in mW/mg and is shown so that endothermic events in the sample pan are recorded as an upward excursion. Percent mass loss is plotted on the right y-axis. The specific vaporization enthalpy of the material in the DSC measurement is determined to be 1880 J/g and is therefore higher than the specific vaporization enthalpies of materials 1 and 2 in FIG. 5.

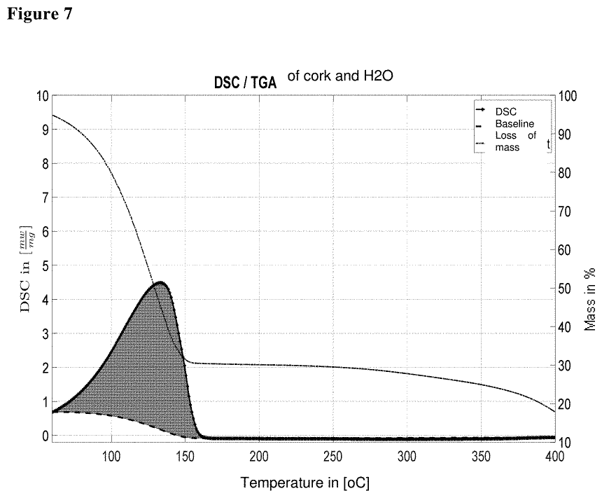

FIG. 7 shows the results of another combined TGA/DSC measurement, at which a heating rate of 10 K/min was used. The sample here consists of cork soaked in water, namely 37.5% by weight cork and 62.5% by weight water. The differential heat flow “DSC” is stated in mW/mg and is shown so that endothermic events in the sample pan are recorded as an upward excursion. Percent mass loss is plotted on the right y-axis. The specific enthalpy of vaporization is determined to be 1224 J/g. This enthalpy is also higher than the specific vaporization enthalpies of materials 1 and 2 in FIG. 5.

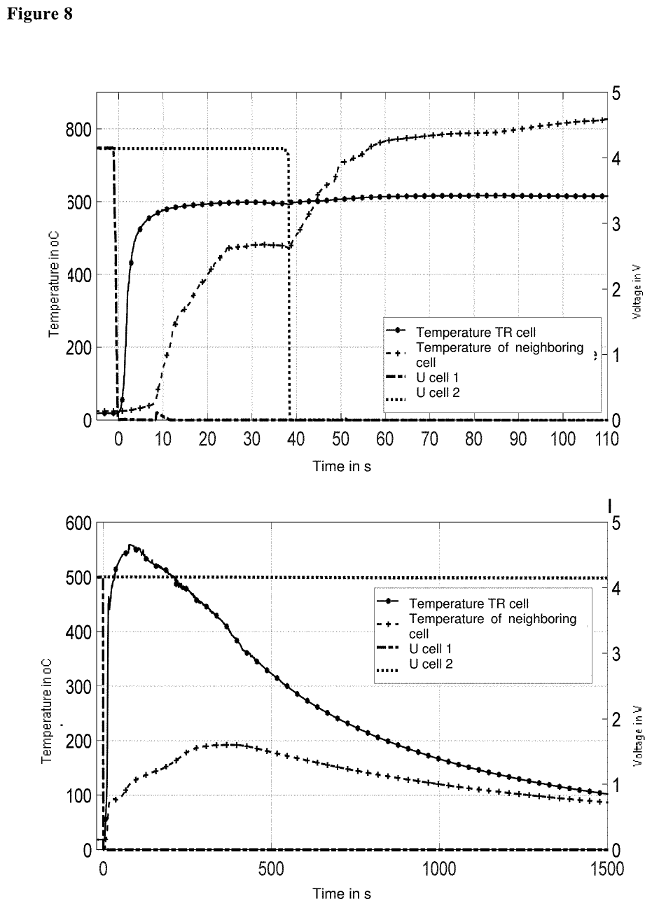

FIG. 8 shows the temperature profiles of a battery (test) module with a structure analogous to FIG. 4.

The temperature profile in the upper diagram corresponds to the temperature profile that was measured for a module without a barrier. The thermal runaway of a battery cell (cell 1, also referred to as the TR cell) is triggered by the nail penetration. The temperature rises sharply after the nail penetration and the voltage drop of cell 1 (U cell 1). The temperature of the neighboring cell (temperature of neighboring cell, cell 2) also rises sharply with a short delay due to the thermal short circuit of both cells (test without barrier). After 38 seconds, the voltage drop in cell 2 can be seen (U cell 2) and the temperature of the neighboring cell, which is thermally runaway, continues to rise. Thermal propagation has taken place.

The temperature profile in the lower diagram is the temperature profile that was measured in a battery (test) module with a barrier according to the invention arranged between the battery cells. As can be clearly seen, the barrier according to the invention can thermally shield the second battery cell to the extent that the critical temperature is not reached.

1. A barrier for preventing propagation of a thermal event within a multi-cell battery module comprising
a thermally and electrically insulating frame structure which has a plurality of cavities which are at least partially filled with a heat-absorbing material,
wherein the heat-absorbing material comprises water and a component based on biogenic raw materials.

2. The barrier of claim 1, wherein the heat absorbing material comprises
70-99.8% by weight water, and
0.2-30% by weight of a component based on biogenic raw materials.

3. The barrier of claim 1, wherein the heat-absorbing material comprises a hydrogel which is a network of at least one biogenic gelling agent and water,
wherein the gelling agent is preferably a polysaccharide and/or gelatin
the polysaccharide is preferably selected from the group consisting of agar-agar, starch, in particular corn starch, starch derivatives, hydroxypropylmethylcellulose, methylcellulose, κ-carrageenan, ι-carrageenan, pectin, gellan, scleroglucan, alginates and combinations thereof.

4. The barrier of claim 1, wherein the heat-absorbing material further comprises 0.05-10% by weight of at least one additive, wherein the at least one additive is preferably selected from the group consisting of rheology modifiers, biocides, salts, flame retardants, dyes and combinations thereof,
the rheology modifiers are preferably selected from the group consisting of xanthan, cellulose, carboxymethyl cellulose, gum arabic, guar gum, maltodextrin and combinations thereof, and
the salts are preferably hydrate salts, particularly preferably hydrate salts selected from the group consisting of Na₂CO₃·10H₂O, Na₂SO₄·10H₂O, Na₃PO₄·12H₂O and MgSO₄·7H₂O.

5. The barrier of claim 1, wherein the heat-absorbing material comprises water-swollen cork particles from tree bark.

6. The barrier of claim 1, wherein the cavities of the frame structure, based on the volume of the cavities, are preferably filled with the heat-absorbing material to at least 65% by volume, preferably to at least 70% by volume, particularly preferably to at least 90% by volume, in particular to at least 98% by volume.

7. The barrier of claim 1, wherein the frame structure contains 60-100% by weight of a polymeric matrix material and 0-40% by weight of fillers, preferably 70-99% by weight of a polymeric matrix material and 1-30% by weight fillers, wherein the polymeric matrix material is preferably selected from the group consisting of polyetheretherketone (PEEK), polyaramid, silicone and combinations thereof, and wherein the fillers are preferably selected from the group consisting of clay, expanded clay, mica, glass, expanded glass, stone, cork particles and combinations thereof.

8. The barrier of claim 1, wherein the frame structure has a coating.

9. The barrier of claim 1, wherein the cavities of the frame structure are sealed to prevent drying out of the heat-absorbing material prior to the occurrence of a thermal event,
preferably with a polymer foil, a metal foil or a laminate of the aforementioned foils,
wherein the polymer foil is preferably selected from the group consisting of polyethylene (PE), polypropylene (PP), polyvinylidene fluoride (PVDF), polychlorotrifluoroethylene (PCTFE), polyphenylene sulfide (PPS), ethylene-tetrafluoroethylene copolymer (ETFE) and combinations thereof and wherein the metal foil is preferably an aluminum foil.

10. The barrier of claim 1, wherein the frame structure is formed as a layer having honeycomb, round or square cross-section cavities, or as a foam, or a combination thereof.

11. The barrier of claim 1, wherein the barrier is formed as a layer with a layer thickness of 0.5 to 20 mm, preferably 0.5 to 5 mm, particularly preferably 0.5 to 2 mm.

12. A multi-cell battery module or battery comprising at least one barrier of claim 1 or a cork layer soaked in water.

13. The battery module of claim 12, wherein the barrier or the cork layer soaked in water is arranged in a space between two cells and/or in a space between an outer cell and a wall of the battery module.

14. A method for preventing the propagation of a thermal event within a multi-cell battery module, in which a barrier of claim 1 or a cork layer soaked in water is arranged between the battery cells.
